(19) United States
(12) Patent Application Publication
(10) Pub. No.: US 2025/0309361 A1
(43) Pub. Date: Oct. 2, 2025

(54) SOLID-STATE BATTERY AND METHOD OF MANUFACTURING SOLID-STATE BATTERY

(71) Applicant: HONDA MOTOR CO., LTD., Tokyo (JP)

(72) Inventors: Takashi TOYOSHIMA, Saitama (JP); Yohei NOJI, Saitama (JP); Kosei MIYATA, Saitama (JP)

(21) Appl. No.: 19/063,363

(22) Filed: Feb. 26, 2025

(30) Foreign Application Priority Data
Mar. 30, 2024 (JP) 2024-058325

(51) Int. Cl. H01M 10/0585; H01M 10/04; H01M 10/056; H01M 50/449; H01M 50/491

(52) U.S. Cl. CPC H01M 10/0585; H01M 10/0468; H01M 10/056; H01M 50/449; H01M 50/491; H01M 2300/0094

(57) ABSTRACT

Provided is a solid-state battery capable of allowing an intermediate layer interposed between a negative electrode layer and a solid electrolyte layer to improve in bondability with another layer. A solid-state battery having a structure in which a negative electrode layer, a solid electrolyte layer, and a positive electrode layer are laminated in this order, includes an intermediate layer interposed between the negative electrode layer and the solid electrolyte layer, and the intermediate layer has a porosity of 46% or less.

This application is based on and claims the benefit of priority from Japanese Patent Application No. 2024-058325, filed on 30 Mar. 2024, the content of which is incorporated herein by reference.

### BACKGROUND OF THE INVENTION

### Field of the Invention

The present invention relates to a solid-state battery and a method of manufacturing a solid-state battery.

### Related Art

In recent years, research and development of secondary batteries that contribute to energy efficiency has been carried out in order to ensure many people have access to affordable, reliable, sustainable, and advanced energy.

As such secondary batteries, solid-state batteries including lithium metal batteries, lithium ion secondary batteries, etc. have been known, in which a solid electrolyte layer is interposed between a positive electrode layer and a negative electrode. A technique pertaining to a solid-state battery that includes a layer between a negative electrode layer and a solid electrolyte layer is disclosed (for example, see U.S. Published Patent Application, Publication No. 2022/158226).

Patent Document 1: U.S. Published Patent Application, Publication No. 2022/158226

### SUMMARY OF THE INVENTION

The solid-state battery disclosed in U.S. Published Patent Application, Publication No. 2022/158226 includes a conformal coating layer between the negative electrode layer and the solid electrolyte layer. The conformal coating layer is considered to contribute to a reduction in interfacial resistance and an improvement of current uniformity. On the other hand, in a case where another layer is interposed between the negative electrode layer and the solid electrolyte layer, the interfacial bondability between these layers also has importance. For example, in a case where layers having a high density are bonded to each other or in a case where layers having a low density are bonded to each other, there is a problem that favorable interface bondability cannot be achieved.

The present invention has been made in view of the above circumstances, and an object of the present invention is to provide a solid-state battery capable of allowing an intermediate layer interposed between a negative electrode layer and a solid electrolyte layer to improve in bondability with another layer that may include at least one of the negative electrode layer or the solid electrolyte layer.

A first aspect of the present invention is directed to a solid-state battery having a structure in which a negative electrode layer, a solid electrolyte layer, and a positive electrode layer are laminated in this order, the solid-state battery including an intermediate layer interposed between the negative electrode layer and the solid electrolyte layer, the intermediate layer having a porosity of 46% or less.

The first aspect provides a solid-state battery capable of allowing the intermediate layer interposed between the negative electrode layer and the solid electrolyte layer to improve in bondability with another layer.

According to a second aspect of the present invention, in the solid-state battery of the first aspect, the porosity of the intermediate layer is 44% or less.

The second aspect allows the intermediate layer interposed between the negative electrode layer and the solid electrolyte layer to further suitably improve in bondability with another layer.

According to a third aspect of the present invention, in the solid-state battery of the first or second aspect, an interface between the intermediate layer and the solid electrolyte layer in contact with the intermediate layer has an arithmetic mean height Sa of 0.2 or more.

The third aspect allows the intermediate layer interposed between the negative electrode layer and the solid electrolyte layer to further suitably improve in bondability with another layer.

According to a fourth aspect of the present invention, in the solid-state battery of any one of the first to third aspects, the solid electrolyte layer in contact with the intermediate layer is constituted by a solid electrolyte material having a particle diameter of 0.2 μm to 5 μm, and contains a binder at a content of 5 mass % to 25 mass %, and the intermediate layer is constituted by particles having a particle diameter of 5 nm to 300 nm, and contains a binder at a content of 1 mass % to 10 mass %.

The fourth aspect allows the intermediate layer interposed between the negative electrode layer and the solid electrolyte layer to further suitably improve in bondability with another layer.

According to a fifth aspect of the present invention, in the solid-state battery of any one of the first to fourth aspects, the solid electrolyte layer includes a plurality of solid electrolyte layer layers, one solid electrolyte layer of the plurality of solid electrolyte layers is disposed toward the negative electrode layer, and an interface between the one solid electrolyte layer and the negative electrode layer has an arithmetic mean height Sa of 1 or less.

The fifth aspect allows improving bondability between a layer, such as the intermediate layer, disposed toward the negative electrode layer and the solid electrolyte layer disposed toward the negative electrode layer.

A sixth aspect of the present invention is directed to a method of manufacturing a solid-state battery having a structure in which a negative electrode layer, a solid electrolyte layer, and a positive electrode layer are laminated in this order, the solid-state battery including an intermediate layer interposed between the negative electrode layer and the solid electrolyte layer. The method includes at least: pressing the intermediate layer in advance; transferring and pressing the intermediate layer subjected to the pressing onto the negative electrode layer, thereby obtaining an intermediate layer-negative electrode layer laminate; disposing and pressing the solid electrolyte layer onto a lamination surface of the intermediate layer of the intermediate layer-negative electrode layer laminate, thereby obtaining a solid electrolyte layer-intermediate layer-negative electrode layer laminate; and integrating and pressing the layers. In the method, a pressing pressure in the pressing the intermediate layer in advance is higher than a pressing pressure in the disposing and pressing the solid electrolyte layer.

The sixth aspect makes it possible to manufacture a solid-state battery capable of allowing the intermediate layer interposed between the negative electrode layer and the solid electrolyte layer to improve in bondability with another layer.

According to a seventh aspect of the present invention, in the method of the sixth aspect, the pressing pressure in the pressing the intermediate layer in advance is 600 MPa or greater and 1200 MPa or less.

The seventh aspect makes it possible to manufacture a solid-state battery capable of allowing the intermediate layer interposed between the negative electrode layer and the solid electrolyte layer to further suitably improve in bondability with another layer.

According to an eighth aspect of the present invention, in the method of the sixth aspect, the pressing the intermediate layer in advance is performed at room temperature or higher and 100° C. or lower.

The eighth aspect makes it possible to densify the intermediate layer.

### BRIEF DESCRIPTION OF THE DRAWINGS

FIG. 1 is a conceptual cross-sectional view illustrating a configuration of a solid-state battery according to an embodiment of the present invention;

FIG. 2A is a diagram illustrating a part of steps of a method of manufacturing a solid-state battery according to the embodiment of the present invention;

FIG. 2B is a diagram illustrating a part of the steps of the method of manufacturing a solid-state battery according to the embodiment of the present invention;

FIG. 2C is a diagram illustrating a part of the steps of the method of manufacturing a solid-state battery according to the embodiment of the present invention; and

FIG. 2D is a diagram illustrating a part of the steps of the method of manufacturing a solid-state battery according to the embodiment of the present invention.

### DETAILED DESCRIPTION OF THE INVENTION

### Solid-State Battery

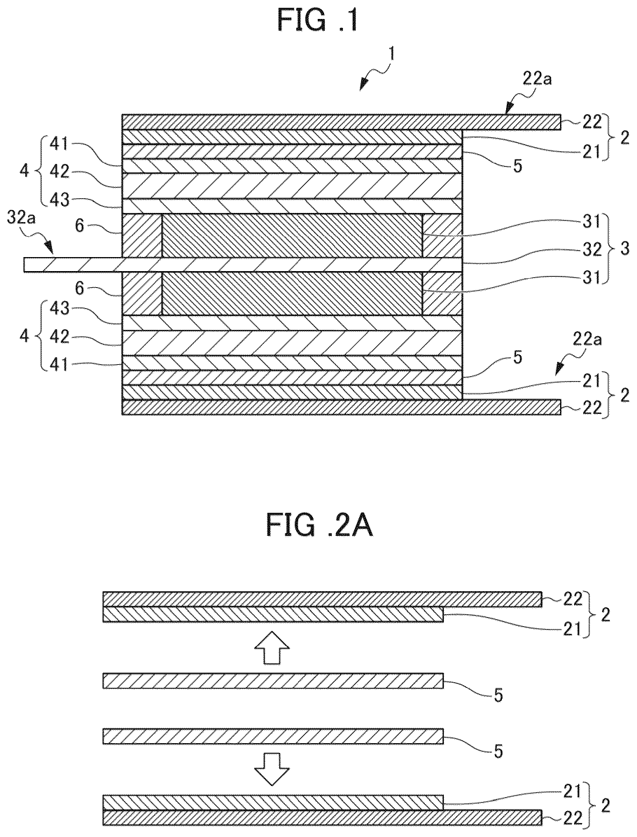

As illustrated in FIG. 1, a solid-state battery 1 includes an electrode laminate in which a negative electrode layer 2, a solid electrolyte layer 4, and a positive electrode layer 3 are laminated in this order. An intermediate layer 5 is interposed between the negative electrode layer 2 and the solid electrolyte layer 4. In the description of the present embodiment, the structure illustrated in FIG. 1, in which the negative electrode layer 2, the intermediate layer 5, the solid electrolyte layer 4, the positive electrode layer 3, the solid electrolyte layer 4, the intermediate layer 5, and the negative electrode layer 2 are laminated in this order, will be referred to as a laminate structure of the solid-state battery 1. However, the structure of the solid-state battery 1 is not limited to the foregoing, and it is sufficient for the solid-state battery 1 to have a structure in which the solid electrolyte layer 4 is laminated between the negative electrode layer 2 and the positive electrode layer 3, and the intermediate layer 5 is interposed between the negative electrode layer 2 and the solid electrolyte layer 4. The solid-state battery 1 may include a component that can be used for a solid-state battery, such as an exterior jacket and the like, in addition to the electrode laminate illustrated in FIG. 1.

The solid-state battery 1 may be a solid-state lithium-ion secondary battery or a lithium metal secondary battery, without any particular limitation.

### Negative Electrode Layer

The negative electrode layer 2 includes a negative electrode active material layer 21 and a negative electrode current collector layer 22. The negative electrode active material layer 21 may be constituted by any material that can be used as a negative electrode active material of a solid-state battery, without any particular limitation. The negative electrode active material layer 21 is preferably a lithium metal layer containing lithium metal as the negative electrode active material. This is because the solid-state battery 1 according to the present invention is configured such that even if the negative electrode active material layer 21 is a hard metal, the negative electrode active material layer 21 can be in tight contact with the solid electrolyte layer 4 with high adhesiveness. The lithium metal includes a lithium alloy and the like in addition to lithium metal alone. The negative electrode active material layer 21 may include, in addition to the above, a silicon-based active material such as Si, a Si alloy, etc., a lithium transition metal oxide such as lithium titanate (Li₄Ti₅O₁₂), etc., a transition metal oxide such as TiO₂, Nb₂O₃, WO₃, etc., a metal sulfide, a metal nitride, a carbon material such as graphite, soft carbon, hard carbon, etc., metal indium, and the like.

The negative electrode active material layer 21 may contain, in addition to the above, a material that can be contained in a negative electrode active material layer of a solid-state battery. Examples of the material include a solid electrolyte, a conductive additive, a binder, etc. Examples of the solid electrolyte include the same solid electrolytes as those contained in the solid electrolyte layer 4, which will be described later. Examples of the conductive additive include carbon black, natural graphite, carbon fibers, carbon nanotubes, etc. Examples of the binder include a nitrile polymer, a polyester polymer, an acrylic acid polymer, a cellulose polymer, a styrene polymer, a styrene butadiene polymer, a vinyl acetate polymer, a urethane polymer, a fluoroethylene polymer, etc.

The negative electrode current collector layer 22 may include copper, nickel, stainless steel, or the like, without any particular limitation. Examples of the shape of the negative electrode current collector layer 22 include a foil shape, a plate shape, a mesh shape, a nonwoven fabric shape, a foamed shape, etc. A part of the negative electrode current collector layer 22 extends in a predetermined direction to form a negative electrode current collector tab 22a.

### Intermediate Layer

The intermediate layer 5 is interposed between the negative electrode layer 2 and the solid electrolyte layer 4. For example, in a case where the solid-state battery 1 is a lithium metal battery, the intermediate layer 5 has a function of causing lithium metal to precipitate uniformly. Due to this function, the interface between the intermediate layer 5 and a first solid electrolyte layer 41 is stabilized. In a case where the solid-state battery 1 is a lithium metal secondary battery having the intermediate layer 5, the solid-state battery 1 may be an anode-free battery in which the negative electrode active material layer 21 does not exist at the time of the initial charge. In this case, a lithium metal layer as the negative electrode active material layer 21 is formed after the initial charge and discharge. In the present embodiment, the intermediate layer 5 is described as being composed of one layer, but the number of layers included in the intermediate layer 5 is not particularly limited.

The intermediate layer 5 may be constituted by any substance, and examples thereof include a metal that can be alloyed with lithium, amorphous carbon, and the like. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), etc. The metal that can be alloyed with lithium may be nanoparticles. Examples of the amorphous carbon include carbon blacks such as acetylene black, furnace black, Ketjhen black, and the like, coke, activated carbon, etc. The amorphous carbon may be graphitizable carbon (soft carbon), or may be non-graphitizable carbon (hard carbon), CNT (carbon nanotube), fullerene, or graphene. The intermediate layer 5 may contain a binder in addition to the above substances. The binder may be the same substance as the binder that can be contained in the negative electrode active material layer 21.

The intermediate layer 5 is densified in advance in a first pressing step, which will be described later. As a result, the bondability between the intermediate layer 5 and the solid electrolyte layer 4 (first solid electrolyte layer 41) can be improved. The intermediate layer 5 has a porosity of 46% or less. The porosity of the intermediate layer 5 is preferably 44% or less, and may be 42% or less. The porosity of the intermediate layer 5 may be 40% or more.

Particles constituting the intermediate layer 5 preferably have a particle diameter of 5 nm to 300 nm. Preferably, the binder is contained at a content of 1 mass % to 15 mass %, preferably 1 mass % to 10 mass %, with respect to the total mass of the intermediate layer 5.

### Solid Electrolyte Layer

The solid electrolyte layer 4 is formed between the intermediate layer 5 and the positive electrode layer 3. In the present embodiment, the solid electrolyte layer 4 has a structure in which the first solid electrolyte layer 41 disposed toward the intermediate layer, a second solid electrolyte layer 42, and a third solid electrolyte layer 43 disposed toward the positive electrode layer are laminated in this order. The configuration of the solid electrolyte layer 4 is not limited to this, and may be composed of one layer or two layers, for example.

The first solid electrolyte layer 41 is disposed in contact with the intermediate layer 5, as illustrated in FIG. 1. The first solid electrolyte layer 41 may be constituted by any solid electrolyte material, provided that the material can be used as an electrolyte of a solid-state battery. Examples of the solid electrolyte material include an inorganic solid electrolyte such as a sulfide solid electrolyte material, an oxide solid electrolyte material, a halide solid electrolyte, a lithium-containing salt, etc. and a polymer solid electrolyte such as a polyethylene oxide, etc. One kind of the foregoing solid electrolyte materials may be used alone, or two or more kinds thereof may be used in combination.

The solid electrolyte material constituting the first solid electrolyte layer 41 is preferably in the form of particles. The solid electrolyte material constituting the first solid electrolyte layer 41 preferably has a particle diameter (D50, median diameter) of 0.2 μm to 5 μm. The particle diameter of the solid electrolyte material is preferably 1 μm or less. This configuration facilitates densification of the first solid electrolyte layer 41. The particle diameter of the solid electrolyte material is more preferably 0.7 μm or less.

The first solid electrolyte layer 41 preferably has a density of 1.65 g/cm³ or greater, and more preferably 1.80 g/cm³ or greater. The density of the first solid electrolyte layer 41 may be 2.00 g/cm³ or less, without any particular limitation.

The first solid electrolyte layer 41 may contain a material that can be used for a solid electrolyte layer of a solid-state battery, in addition to the solid electrolyte material. For example, the first solid electrolyte layer 41 may contain a binder. The binder for the first solid electrolyte layer 41 may be the same substance as the binder that can be contained in the negative electrode active material layer 21. In a case where the first solid electrolyte layer 41 contains a binder, the content of the binder is preferably 5 mass % to 25 mass % with respect to the total mass of the first solid electrolyte layer 41.

Interface roughness of the interface between the intermediate layer 5 and the first solid electrolyte layer 41 is optimized by adjusting the particle size of the particles constituting the intermediate layer 5, the content of the binder in the intermediate layer 5, the particle size of the solid electrolyte material constituting the first solid electrolyte layer 41, and the content of the binder in the first solid electrolyte layer 41. As a result, the bondability between the intermediate layer 5 and the first solid electrolyte layer 41 can be improved. The interface roughness of the interface between the intermediate layer 5 and the first solid electrolyte layer 41 is represented by, for example, an arithmetic mean height Sa. The arithmetic mean height Sa is preferably 0.2 or more. More preferably, the arithmetic mean height Sa is 1 or less.

The thickness of the first solid electrolyte layer 41 (length in the lamination direction of the layers) is preferably 7 μm or less. This configuration facilitates densification of the first solid electrolyte layer 41. The thickness of the first solid electrolyte layer 41 is more preferably 3 μm or less. The thickness of the first solid electrolyte layer 41 may be 1 μm or more, without any particular limitation.

The first solid electrolyte layer 41 preferably has a porosity of 7% or less. With a porosity within this range, it can be said that the first solid electrolyte layer 41 is densified. In addition, a porosity within this range contributes to improving efficiency of charge transfer within the first solid electrolyte layer 41. The porosity of the first solid electrolyte layer 41 is more preferably 4% or less. The porosity of the first solid electrolyte layer 41 may be 1% or more, without any particular limitation.

The configuration of the second solid electrolyte layer 42 and that of the third solid electrolyte layer 43 are not particularly limited, and may be the same as the configuration of the first solid electrolyte layer 41. In the present embodiment, the third solid electrolyte layer 43 is disposed in contact with the positive electrode layer 3. The second solid electrolyte layer 42 is interposed between the first solid electrolyte layer 41 and the third solid electrolyte layer 43. It is possible to arbitrarily determine whether to provide the second solid electrolyte layer 42 and the third solid electrolyte layer 43 separately from the first solid electrolyte layer 41. On the other hand, it is effective to provide a high-density solid electrolyte layer or a high-strength solid electrolyte layer including a support, in addition to the first solid electrolyte layer 41 which is a layer for improving interfacial bondability. Examples of the support include a three-dimensional structure such as a mesh, a woven fabric, a nonwoven fabric, an embossed body, a punched body, an expanded body, a foamed body, etc.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are respectively laminated on both surfaces of one positive electrode current collector layer 32. On the other hand, the positive electrode layer 3 is not limited to this configuration, but may have a configuration in which one positive electrode active material layer 31 is laminated on one surface of one positive electrode current collector layer 32.

Each positive electrode active material layer 31 may be constituted by a material that can be used as a positive electrode active material of a solid-state battery, without any particular limitation. Examples of the positive electrode active material constituting each positive electrode active material layer 31 include layered positive electrode active material particles such as LiCoO₂, LiNiO₂, LiCoₓNi_{y}Mn_{z}O₂ (x+y+z=1), LiVO₂, LiCrO₂, etc., a spinel type positive electrode active material such as LiMn₂O₄, Li(Ni_{0.25}Mn_{0.75})₂O₄, LiCoMnO₄, Li₂NiMn₃O₈, etc., an olivine type positive electrode active material such as LiCoPO₄, LiMnPO₄, LiFePO₄, etc., a solid solution oxide (Li₂MnO₃—LiMO₂ (M═Co, Ni, etc.)), a conductive polymer such as polyaniline, polypyrrole, etc., a sulfide such as Li₂S, CuS, a Li—Cu—S compound, TiS₂, FeS, MoS₂, a Li—Mo—S compound, etc., a mixture of sulfur and carbon, and the like. One kind of the foregoing positive electrode active materials may be used alone, or two or more of kinds thereof may be used in combination.

An insulating frame 6 may be provided along the outer periphery of each positive electrode active material layer 31. The insulating frame 6 can prevent or reduce short-circuiting in the solid-state battery 1 and increase strength of the solid-state battery 1. In the present embodiment, the insulating frames 6 are disposed so as to cover the side surfaces of the two positive electrode active material layers 31 formed on both surfaces of the positive electrode current collector layer 32. Each insulating frame 6 is in contact with a part of the lamination surface of the positive electrode current collector layer 32 and has a gap through which a positive electrode current collector tab 32a described later extends. Each insulating frame 6 may be constituted by any material, and examples thereof include an insulating oxide such as alumina, etc., a resin such as polyvinylidene fluoride (PVDF), etc., and rubber such as styrene-butadiene rubber (SBR) etc., and the like.

The positive electrode current collector layer 32 may be constituted by any material, example thereof include aluminum, stainless steel, conductive carbon (graphite, carbon nanotube, etc.), and the like. Examples of the shape of the positive electrode current collector layer 32 include a foil shape, a plate shape, a mesh shape, a nonwoven fabric shape, a foamed shape, etc. A part of the positive electrode current collector layer 32 extends in a predetermined direction to form the positive electrode current collector tab 32a.

### Method of Manufacturing Solid-State Battery

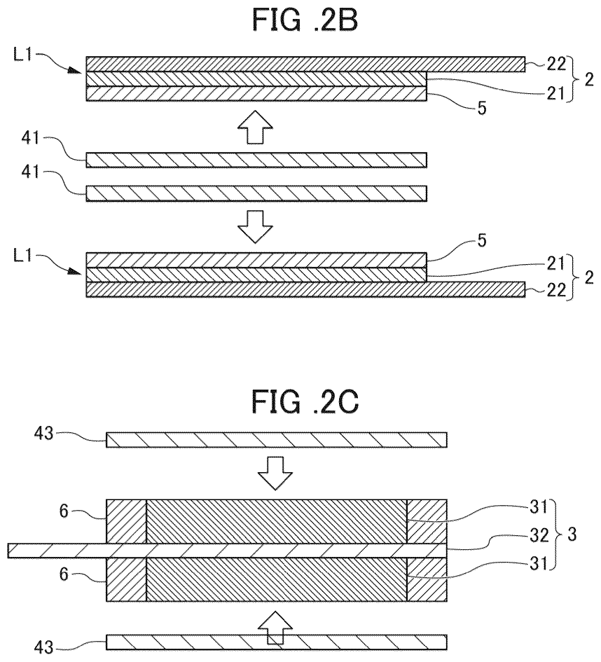

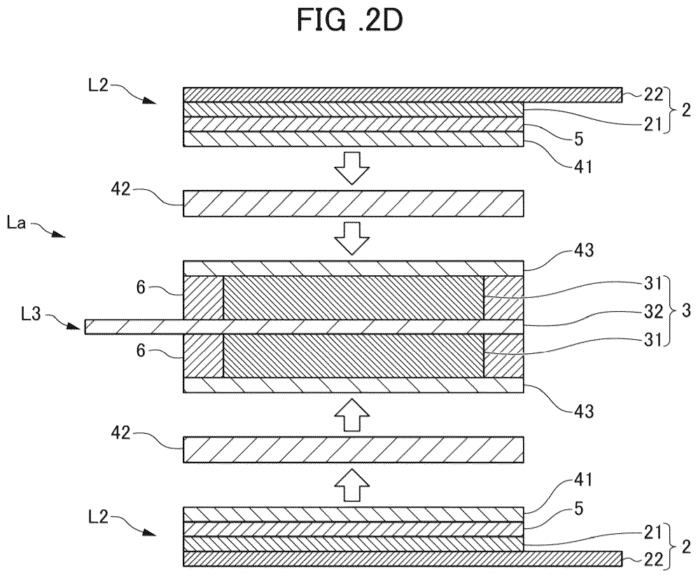

A method of manufacturing a solid-state battery according to the present embodiment will be described below with reference to FIGS. 2A to 2D. The method of manufacturing a solid-state battery according to the present embodiment is adapted for manufacturing a solid-state battery that includes an electrode laminate La in which a negative electrode layer 2, an intermediate layer 5, a solid electrolyte layer 4, and a positive electrode layer 3 are laminated in this order. The method of manufacturing a solid-state battery according to the present embodiment includes at least: a first pressing step of pressing the intermediate layer 5 in advance; a second pressing step of transferring and pressing the intermediate layer 5 subjected to the first pressing step onto the negative electrode layer 2, thereby obtaining an intermediate layer-negative electrode layer laminate L1; a third pressing step of disposing and pressing the solid electrolyte layer 4 onto a lamination surface of the intermediate layer 5 of the intermediate layer-negative electrode layer laminate L1, thereby obtaining a solid electrolyte layer-intermediate layer-negative electrode layer laminate, and an integrating-pressing step of integrating the above-described layers. The first pressing step, the second pressing step, and the third pressing step are performed in this order.

The first pressing step is for densifying the intermediate layer 5 by pressing it in advance. The intermediate layer 5 is formed, for example, by applying a slurry prepared by dispersing a material for constituting the intermediate layer 5 in a solvent to a support sheet, and drying the slurry. By pressing the intermediate layer 5 in this state, the intermediate layer 5 is densified, whereby the intermediate layer 5 having a porosity of 46% or less is eventually formed. The pressing pressure in the first pressing step is higher than the pressing pressure in the third pressing step, which will be described later. For example, the pressing pressure in the first pressing step is preferably 600 MPa or greater and 1200 MPa or less, and more preferably 800 MPa or greater.

The pressing in the first pressing step is preferably performed at room temperature or higher and 100° C. or lower. The room temperature means, for example, 25° C. Setting the pressing temperature within the above range makes it possible to suitably densify the intermediate layer.

As illustrated in FIG. 2A, the second pressing step includes press-bonding the negative electrode layer 2 and the intermediate layer 5 subjected to the first pressing step, thereby obtaining the intermediate layer-negative electrode layer laminate L1. Specifically, the intermediate layer 5 can be disposed on a surface of the negative electrode active material layer 21, which is the lamination surface of the negative electrode layer 2, by being transferred by means of the above-described support sheet (intermediate layer transfer sheet). In the second pressing step, the negative electrode layer 2 and the intermediate layer 5 can be pressed at any pressing pressure as long as the negative electrode layer 2 and the intermediate layer 5 can be bonded to each other such that the layers 2 and 5 are not excessively deformed and will not be peeled off in a later step. For example, the pressing pressure in the second pressing step is within the range of 300 MPa or greater and 800 MPa or less.

As illustrated in FIG. 2B, the third pressing step includes disposing a substance that constitutes the solid electrolyte layer 4 (in the present embodiment, the first solid electrolyte layer 41) on a lamination surface of the intermediate layer 5 of the intermediate layer-negative electrode layer laminate L1, and press-bonding the substance, thereby obtaining the solid electrolyte layer-intermediate layer-negative electrode layer laminate L2. The first solid electrolyte layer 41 can be disposed on the lamination surface of the intermediate layer 5 by using a solid electrolyte layer transfer sheet or using a solid electrolyte sheet prepared by forming the solid electrolyte into a sheet shape in advance. The solid electrolyte layer transfer sheet has the same configuration as the above-described intermediate layer transfer sheet.

For example, the third pressing step is preferably performed at a pressing pressure of 500 MPa or greater and 800 MPa or less, and more preferably 600 MPa or greater.

As illustrated in FIG. 2C, the solid electrolyte layer 4 may be provided as a plurality of layers, among which a third solid electrolyte layer 43 may be disposed toward the positive electrode layer 3. In this case, the method may include a fourth pressing step of disposing and press-bonding a substance that constitutes the third solid electrolyte layer 43 onto a lamination surface of the positive electrode layer 3, thereby obtaining a solid electrolyte layer-positive electrode layer laminate L3. In the present embodiment, the positive electrode layer 3 includes positive electrode active material layers 31 formed on both surfaces of a positive electrode current collector layer 32, and the third solid electrolyte layers 43 are disposed on both of the positive electrode active material layers 31. The fourth pressing step has to be performed before the integrating-pressing step, without any particular limitation.

As illustrated in FIG. 2D, the integrating-pressing step includes press-bonding the layer including the positive electrode layer 3 and the solid electrolyte layer-intermediate layer-negative electrode layer laminate L2, thereby obtaining the electrode laminate La. The layer including the positive electrode layer 3 may be the positive electrode layer 3 alone or may be the solid electrolyte layer-positive electrode layer laminate L3 obtained in the fourth pressing step. In the integrating-pressing step, a second solid electrolyte layer 42 may be interposed between the solid electrolyte layer-intermediate layer-negative electrode layer laminate L2 and the positive electrode layer 3 or the solid electrolyte layer-positive electrode layer laminate L3 such that the second solid electrolyte layer 42 face the other solid electrolyte layers, and then, press-bonding may be performed.

Since the integrating-pressing step is for integrating the layers, the pressing pressure is preferably set to a level at which the layers are not excessively deformed. For example, the pressing pressure in the integrating-pressing step is within the range of 500 MPa or greater and 900 MPa or less.

In each of the above-described steps, the press-bonding may be performed by any apparatus, and example thereof include a roll press apparatus, a plate press apparatus, and an isostatic press (CIP, WIP) apparatus. In a case where the press-bonding is performed by a roll press apparatus, the components to be press-bonded may be conveyed to the roll press apparatus in the same direction or different directions. Each of the above-described steps may be performed at room temperature, specifically at 10° C. to 35° C., for example.

It should be noted that the present invention is not limited to the preferred embodiments described above, and can be arbitrarily modified within a range in which the spirit of the present invention is not impaired.

### EXPLANATION OF REFERENCE NUMERALS

1: Solid-state battery
2: Negative electrode layer
3: Positive electrode layer
4: Solid electrolyte layer
5: Intermediate layer

What is claimed is:

1. A solid-state battery having a structure in which a negative electrode layer, a solid electrolyte layer, and a positive electrode layer are laminated in this order, the solid-state battery comprising:
an intermediate layer interposed between the negative electrode layer and the solid electrolyte layer,
the intermediate layer having a porosity of 46% or less.

2. The solid-state battery according to claim 1, wherein the porosity of the intermediate layer is 44% or less.

3. The solid-state battery according to claim 1, wherein
an interface between the intermediate layer and the solid electrolyte layer in contact with the intermediate layer has an arithmetic mean height Sa of 0.2 or more.

4. The solid-state battery according to claim 1, wherein
the solid electrolyte layer in contact with the intermediate layer is constituted by a solid electrolyte material having a particle diameter of 0.2 μm to 5 μm, and contains a binder at a content of 5 mass % to 25 mass %, and
the intermediate layer is constituted by particles having a particle diameter of 5 nm to 300 nm, and contains a binder at a content of 1 mass % to 10 mass %.

5. The solid-state battery according to claim 1, wherein
the solid electrolyte layer comprises a plurality of solid electrolyte layer layers,
one solid electrolyte layer of the plurality of solid electrolyte layers is disposed toward the negative electrode layer, and
an interface between the one solid electrolyte layer and the negative electrode layer has an arithmetic mean height Sa of 1 or less.

6. A method of manufacturing a solid-state battery having a structure in which a negative electrode layer, a solid electrolyte layer, and a positive electrode layer are laminated in this order, the solid-state battery including an intermediate layer interposed between the negative electrode layer and the solid electrolyte layer, the method comprising at least:
pressing the intermediate layer in advance;
transferring and pressing the intermediate layer subjected to the pressing onto the negative electrode layer, thereby obtaining an intermediate layer-negative electrode layer laminate;
disposing and pressing the solid electrolyte layer onto a lamination surface of the intermediate layer of the intermediate layer-negative electrode layer laminate, thereby obtaining a solid electrolyte layer-intermediate layer-negative electrode layer laminate; and
integrating and pressing the layers, wherein
a pressing pressure in the pressing the intermediate layer in advance is higher than a pressing pressure in the disposing and pressing the solid electrolyte layer.

7. The method according to claim 6, wherein
the pressing pressure in the pressing the intermediate layer in advance is 600 MPa or greater.

8. The method according to claim 6, wherein
the pressing the intermediate layer in advance is performed at room temperature or higher and 100° C. or lower.
